(19) United States
(12) Patent Application Publication
(10) Pub. No.: US 2022/0063487 A1
(43) Pub. Date: Mar. 3, 2022

(54) WINDOW

(71) Applicant: HONDA MOTOR CO., LTD., Tokyo (JP)

(72) Inventors: Yoshitaka MIMURA, Saitama (JP); Yuji TSUCHIYA, Saitama (JP); Takashi OSHIMA, Saitama (JP)

(73) Assignee: HONDA MOTOR CO., LTD., Tokyo (JP)

(21) Appl. No.: 17/412,910

(22) Filed: Aug. 26, 2021

(30) Foreign Application Priority Data
Aug. 27, 2020 (JP) 2020-143966

(51) Int. Cl. B60Q 1/50; B60J 1/18; B60S 1/58; B60K 35/00; B60Q 1/00; B60Q 1/26; G02B 27/00

(52) U.S. Cl. CPC B60Q 1/503; B60J 1/18; B60S 1/583; B60K 35/00; B60Q 1/0011; G02B 2027/0196; G02B 27/0006; B60Q 2400/50; B60K 2370/1529; B60K 2370/785; B60Q 1/268

(57) ABSTRACT

A rear window that is provided with a vehicle display device for displaying information toward the outside of the vehicle, includes a rear display portion on which the information is projected, in which in which at least a part of an outer surface of the rear display portion has hydrophilicity.

### CROSS-REFERENCE TO RELATED APPLICATIONS

The present application claims the benefit of priority of Japanese Patent Application No. 2020-143966, filed on Aug. 27, 2020, the content of which is incorporated herein by reference.

### TECHNICAL FIELD

The present invention relates to a window, and more particularly to a window provided with a vehicle display device for displaying information toward the outside of a vehicle.

### BACKGROUND ART

In general, in a window for a vehicle, in order to avoid a poor visibility due to rainwater, the outer surface of the window is hydrophobic, and water droplets attached to the outer surface of the window are treated so as to easily fall (for example, see JP-A-2003-321251).

In addition, in recent years, there has been proposed a technique for displaying various kinds of information emitted from a vehicle display device on a window of a vehicle to a traffic participant (including pedestrians, bicycles, motorcycles, other vehicles, and the like) present around the vehicle.

### SUMMARY OF INVENTION

However, when trying to displaying the information emitted from the vehicle display device on the window on which the hydrophobic treatment is performed as described above, the information from the vehicle display device is reflected by the water droplets on the window at the time of precipitation in which the outer surface of the window is exposed to rainwater, and the visibility of the display portion is deteriorated.

Therefore, the present environment provides a window excellent in visibility of a display portion even at the time of precipitation.

The present environment relates to a window, which is provided with a vehicle display device for displaying information toward the outside of a vehicle, the window comprising:

a display portion on which the information is projected,

in which at least a part of the outer surface of the display portion has hydrophilicity.

According to the present environment, even at the time of precipitation in which the outer surface of the window is exposed to rainwater, the information from the vehicle display device is suppressed from being reflected by the water droplets, and the visibility of the display portion is improved.

### BRIEF DESCRIPTION OF DRAWINGS

FIG. 1 is an overall configuration diagram of an autonomous vehicle including a window according to an embodiment of the present invention.

FIG. 2 is an external view showing a front structure of the autonomous vehicle.

FIG. 3 is an external view showing a rear structure of the autonomous vehicle.

FIG. 4 is a sectional view taken along a line A-A of FIG. 3.

FIG. 5 is an external view showing a rear structure of an autonomous vehicle including a window according to a first modification of the present embodiment.

FIG. 6 is a sectional view taken along a line B-B of FIG. 5.

FIG. 7 is an external view showing a rear structure of an autonomous vehicle including a window according to a second modification of the present embodiment.

FIG. 8 is an explanatory view for explaining hydrophobicity and hydrophilicity.

### DESCRIPTION OF EMBODIMENTS

Hereinafter, a vehicle including a window according to an embodiment of the present invention and capable of automatic movement (hereinafter, also referred to as an autonomous vehicle) will be described with reference to the accompanying drawings. In the following description, the left-right direction, the front-rear direction, and the upper-lower direction will be defined and described with reference to the front in the traveling direction of the autonomous vehicle.

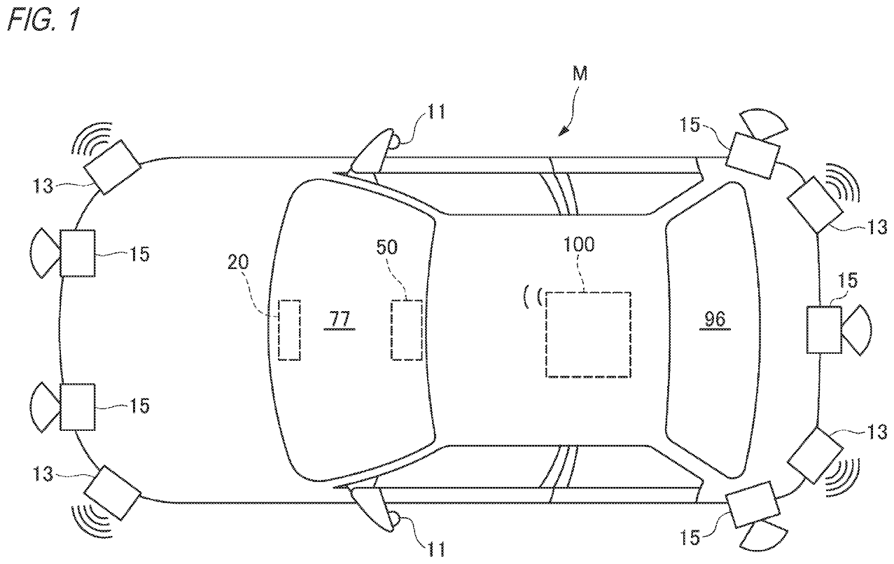

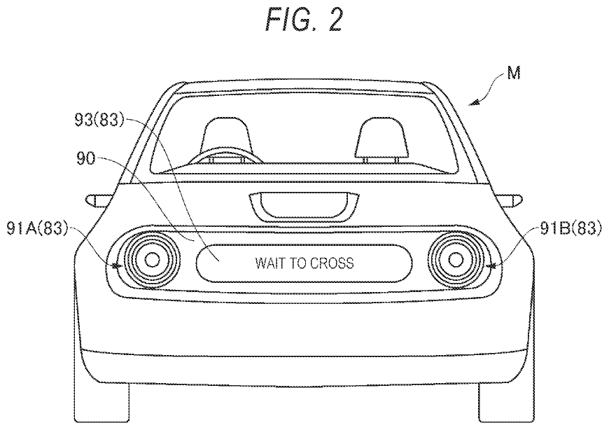

First, an autonomous vehicle will be described with reference to FIGS. 1 and 2. As illustrated in FIG. 1. an autonomous vehicle M according to the present embodiment is, for example, a vehicle such as a two-wheeled vehicle, a three-wheeled vehicle, or a four-wheeled vehicle. The autonomous vehicle M includes a vehicle having an internal combustion engine such as a diesel engine or a gasoline engine as a power source, an electric vehicle having an electric motor as a power source, a hybrid vehicle having both an internal combustion engine and an electric motor, and the like. Among them, the electric vehicle is driven, for example, by using electric power discharged by a battery such as a secondary battery, a hydrogen fuel cell, a metal fuel cell, or an alcohol fuel cell.

As illustrated in FIG. 1, a plurality of external cameras 11, a radar 13, and a light detection and ringing 15 (Lidar) around the body of the autonomous vehicle M are mounted in the autonomous vehicle M, and detect external world information about a target including an object or a sign present around the vehicle M and automatically drive the vehicle.

Further, in the vehicle cabin, a sensor unit 50 configured by combining a plurality of outside information acquisition devices, display devices, and the like, a navigation device 20 having a function of mapping the current position of the autonomous vehicle M on a map and performing route guidance to a destination, and the like, and a vehicle control device 100 having a function of performing autonomous travel control of the autonomous vehicle M including steering and acceleration/deceleration of the autonomous vehicle M, and the like are mounted.

These devices and equipments are connected to each other so as to be able to communicate with each other via a communication medium such as a controller area network (CAN). Note that the vehicle control device 100 may include various sensors, a human machine interface (HMI), and the like in addition to various control devices related to autonomous traveling.

The vehicle external cameras 11 provided in the left and right door front portions and the like periodically and repeatedly image a state of the right rear side and the left rear side in the autonomous vehicle M, and the image information is transmitted to the vehicle control device 100 via the communication medium.

The radar 13 has a function of acquiring distribution information of a target including a distance to the target and an azimuth of the target by receiving the radar wave reflected by the target, while irradiating the target including a preceding vehicle, which is a target to be tracked, which travels in front of the autonomous vehicle M with the radar wave. As the radar wave, a laser, a microwave, a millimeter wave, an ultrasonic wave, or the like can be appropriately used. In the present embodiment, as illustrated in FIG. 1, there are total four radars 13, two are provided on the front side and two are provided on the rear side. The distribution information of the target by the radar 13 is transmitted to the vehicle control device 100 via the communication medium.

The lidar 15 has a function of detecting the presence or absence of the target and the distance to the target by measuring the time required to detect the scattered light with respect to the irradiation light, for example. In the present embodiment, as illustrated in FIG. 1, there are total six lidars 15 disposed around the autonomous vehicle M, two are provided on the front side, one is provided inside the sensor unit 50, and three are provided on the rear side. The distribution information of the target by the lidars 15 is transmitted to the vehicle control device 100 via the communication medium.

The navigation device 20 is configured to include a global navigation satellite system (GNSS) receiver, map information (navigation map), a touch panel type internal display device that functions as a human machine interface, a speaker, a microphone, and the like. The navigation device 20 calculates the current position of the autonomous vehicle M by the GNSS receiver, and derives a route from the current position to a destination designated by the user.

The route derived by the navigation device 20 is provided to a target lane determination portion of the vehicle control device 100. When the vehicle control device 100 is set to a manual driving mode, the navigation device 20 guides the route to the destination by voice or map display.

As illustrated in FIG. 2, the autonomous vehicle M includes an external display mechanism 83 that displays various types of information to traffic participants (including pedestrians, bicycles, motorcycles, other vehicles, and the like) present around the autonomous vehicle M. The external display mechanism 83 is provided on a right front light portion 91A and a left front light portion 91B that are provided so as to be spaced apart from each other in the vehicle width direction, and a front display portion 93 that is disposed between the left and right front light portions 91A, 91B among a front grille 90 in the autonomous vehicle M.

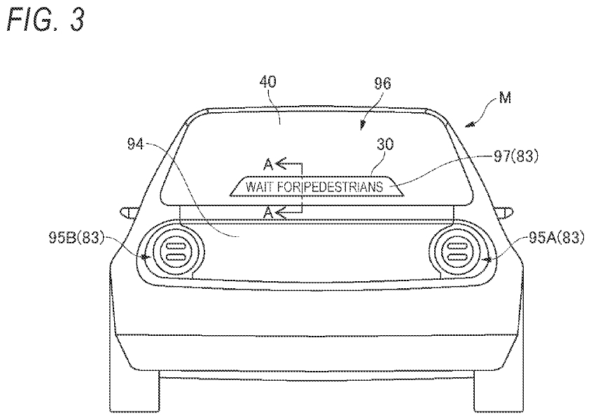

As illustrated in FIG. 3, the external display mechanism 83 is provided in a right rear light portion 95A and a left rear light portion 95B that are provided so as to be spaced apart from each other in the vehicle width direction in the rear grille 94 in the autonomous vehicle M, and a rear display portion 97 that is disposed in a position that can be seen from the outside through the center lower portion of a rear window 96 in the vehicle cabin of the autonomous vehicle M.

In addition to the various devices described above, a communication device, a. vehicle sensor, an HMI (Human Machine Interface), a traveling driving force output device, a steering device, and a. brake device (not illustrated) are mounted on the autonomous vehicle M, and data communication is performed with the vehicle control device 100 via the communication medium. When the autonomous vehicle M is set to the autonomous driving mode, the external cameras 11. the radars 13, the lidars 15, the sensor unit 50 to be described later, and the like acquire external environment information related to automatic movement and perform autonomous driving.

<Rear Display Unit>

Next, the rear window 96 provided with the external display mechanism 83 will be described with reference to FIGS. 3 to 8.

As illustrated in FIG. 3, the rear window 96 has a substantially trapezoidal shape when viewed from the rear. In the rear window 96, a rear display portion 97 (hereinafter, simply referred to as a display portion 97) is provided at a lower portion of the center, and a non-display portion 40 is provided so as to surround the display portion 97.

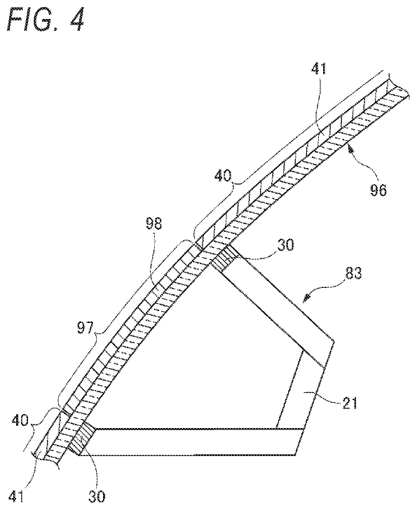

The external display mechanism 83 includes a display portion 97 and a display device 21 provided inside the display portion 97, that is, on the vehicle cabin side, and the display portion 97 transmits light emitted from the display device 21 and displays various information to the outside of the vehicle. For example, information including an action plan of the autonomous vehicle M, information related to display of a traffic signal and the like are displayed on the display portion 97. As illustrated in FIG. 4, around the display portion 97, for example, a black ceramic layer 30 surrounding the display portion 97 is provided on the inner surface (surface on the vehicle cabin side) of the rear window 96, and the display portion 97 is isolated from the non-display portion 40.

The non-display portion 40 is a region excluding a portion transmits light emitted from the display device 21, and is provided above, leftward, rightward, and downward of the display portion 97. When the display portion 97 is located at the lowermost portion of the rear window 96, the non-display portion 40 may be provided only on the above, the leftward, and the rightward of the display portion 97.

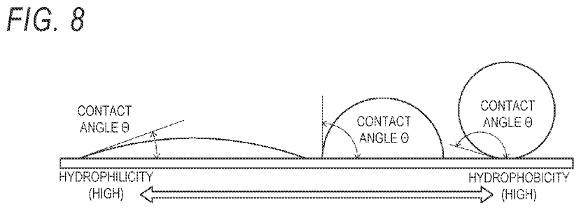

As illustrated in FIG. 4, a hydrophobic layer 41 having hydrophobicity is provided on the outer surface of the non-display portion 40. The hydrophobic layer 41 may be formed by applying a hydrophobic material, may be formed by adhering a hydrophobic film, or may be formed by another method. In a case where the glass itself constituting the rear window 96 has hydrophobicity, application of the hydrophobic material, adhesion of a hydrophobic film, and the like are not required. Hydrophobicity refers to the property of repelling water, and “having hydrophobicity” means that the contact angle θ of water droplets with respect to the outer surface of the window is not less than 90° and not more than 180°, as illustrated in FIG. 8. Since the non-display portion 40 has hydrophobicity, water droplets flow in the non-display portion 40 so as to roll. Therefore, even at the time of precipitation in which the outer surface of the window is exposed to rainwater it is easier for the occupant in the vehicle cabin to see the outside.

On the other hand, when the light emitted from the display device 21 is transmitted to the window having hydrophobicity, the information from the display device 21 is reflected by the water droplets adhering to the window or the water droplets flowing through the window, and the visibility from the outside is deteriorated. Therefore, the display portion 97 on which the information from the display device 21 is projected is provided with the hydrophilic layer 98 having hydrophilicity. The hydrophilic layer 98 may be formed by applying a hydrophilic material, may be formed by adhering a hydrophilic coat layer, or may be formed by another method. When the glass itself constituting the rear window 96 has hydrophilicity, application of the hydrophilic material, adhesion of the hydrophilic film, and the like are not required. The term “hydrophilicity” means that the contact angle θ of water droplets with respect to the outer surface of the window is 0° or more and less than 90°, as illustrated in FIG. 8. Since the display portion 97 has hydrophilicity, the water flows in the display portion 97 so as to spread. Accordingly, even at the time of precipitation in which the outer surface of the rear window 96 is exposed to rainwater, reflection of information from the display device 21 is suppressed, and the visibility of the display portion 97 is improved.

In addition, on the outer surface of the rear window 96, a hydrophilic layer 98 having hydrophilicity may be provided on the outer surface of the display portion 97, that is, on the outermost portion, and other layers such as an antireflection layer, an ultraviolet blocking layer, and a heat shield layer may be provided as long as a hydrophobic layer 41 haying hydrophobicity is provided on the outer surface of the non-display portion 40, that is, the outermost portion. In addition, the hydrophilic layer 98 may have hydrophilicity, and may have other functions such as an ultraviolet ray shielding function and a heat shielding function. Similarly, the hydrophobic layer 41 only needs to have hydrophobicity, and may have other functions such as an ultraviolet blocking function and a heat shielding function.

In addition, even on the outer surface of the display portion 97, it is not necessary for the entirety to be the hydrophilic layer 98, and for example, the region where the information from the display device 21 such as the outer peripheral edge portion is not displayed may not necessarily have hydrophilicity.

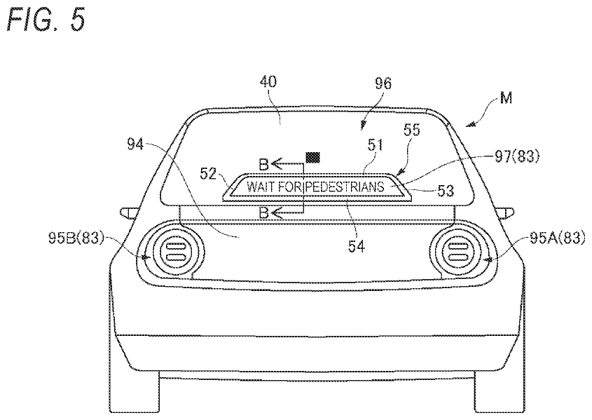

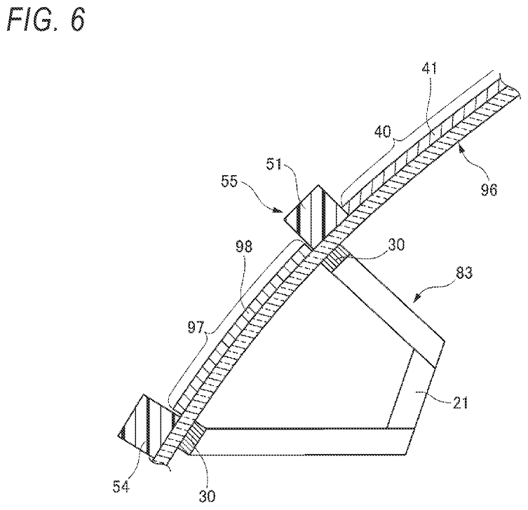

FIGS. 5 and 6 are views illustrating a modification (first modification) of the above-described embodiment.

In the rear window 96 of the first modification, at least above the display portion 97, a liquid guide portion 55 for preventing liquid from entering the display portion 97 is provided so as to protrude from the outer surface of the rear window 96. As a result, it is possible to prevent rainwater from flowing into the display portion 97.

The liquid guide portion 55 of the present modification includes an upper guide portion 51 provided in an upper portion of the display portion 97, a left guide portion 52 and a right guide portion 53 provided on both sides in the vehicle width direction, and a lower guide portion 54 provided in a lower portion of the display portion 97, which are disposed so as to surround the display portion 97. The left guide portion 52 is configured to be inclined to the left side from the upper guide portion 51 toward the lower side, and the right guide portion 53 is configured to be inclined to the right side from the upper guide portion 51 toward the lower side. Therefore, the rainwater flowing through the liquid guide portion 55 can be drained to the left and right so as to avoid the display portion 97.

The liquid guide portion 55 may be made of rubber or resin, Note that the liquid guide portion 55 may be provided at least on the upper portion of the display portion 97, and the lower guide portion 54 may be omitted, and the left guide portion 52 and the right guide portion 53 may be omitted. Further, a guide groove extending to the left guide portion 52 and the right guide portion 53 like a gutter may be provided in the upper guide portion 51.

As described above, according to the first modification, it is possible to prevent rainwater from flowing into the display portion 97, and thus the visibility of the display portion 97 is further improved.

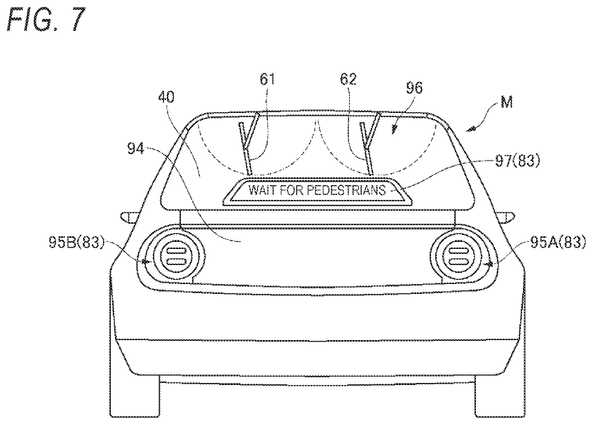

FIG. 7 is a view illustrating another modification (second modification) of the above-described embodiment.

In the rear window 96 of the second modification, a wiper is provided in the non-display portion 40 located above the display portion 97. In the example of FIG. 7, the pair of wipers 61, 62 are provided on the left and right sides, but one wiper may be provided in the center. As described above, according to the second modification, water droplets of the non-display portion 40 can be removed, and even at the time of precipitation, it is easier for the occupant in the vehicle cabin to see the outside.

Although the embodiment is described above with reference to the drawings, it is needless to say that the present invention is not limited to such an example. It will be apparent to those skilled in the art that various changes and modifications may be conceived within the scope of the claims, It is also understood that the various changes and modifications belong to the technical scope of the present invention. Components in the embodiment described above may be combined freely within a range not departing from the spirit of the invention.

For example, the above-described embodiment has been described by exemplifying the rear window 96 as the window of the present invention, the window of the present invention may be another window provided with the external display mechanism 83, which may be applied to the right front light portion 91A, the left front light portion 91B, the front display portion 93, the right rear light portion 95A, and the left rear light portion 95B.

The window of the present invention may not include a non-display portion.

At least the following matters are described in the present specification. Although the corresponding constituent elements or the like in the above-described embodiments are shown in parentheses, the present invention is not limited thereto.

(1) A window (rear window 96) that is provided with a vehicle display device (display device 21) for displaying information toward the outside of the vehicle, including:

a display portion (rear display portion 97) on which the information is projected, in which

in which at least a part of an outer surface of the display portion has hydrophilicity.

According to (1), even at the time of precipitation in which the outer surface of the window is exposed to rainwater, the information from the vehicle display device is suppressed from being reflected by the water droplets, and the visibility of the display portion is improved,

(2) The window according to (1), further including:

a non-display portion (non-display portion 40) on which the information is not projected, in which

an outer surface of the non-display portion has hydrophobicity,

According to (2), since the outer surface of the non-display portion has hydrophobicity, rainwater falls as water droplets from the outer surface of the non-display portion even at the time of precipitation. Accordingly, it is easier for the occupant in the vehicle cabin to see the outside.

(3) The window according to (2), in which

the display portion is located below the window, and

a liquid guide portion (liquid guide portion 55) for preventing liquid from entering the display portion is provided above the display portion so as to protrude from an outer surface of the window.

According to (3), since the liquid guide portion is provided above the display portion so as to protrude from the outer surface of the window, it is possible to prevent rainwater from flowing into the display portion,

(4) The window according to (3), in which

the liquid guide portion includes:

an upper guide portion (upper guide portion 51) provided in an upper portion of the display portion, and

a left guide portion (left guide portion 52) and a right guide portion (right guide portion 53) provided on both sides in the vehicle width direction,

the left guide portion is configured to be inclined to a left side from the upper guide portion toward a lower side, and

the right guide portion is configured to be inclined to a right side from the upper guide portion toward the lower side.

According to (4), the rainwater flowing through the liquid guide portion can be drained to the left and right so as to avoid the display portion.

(5) The window according to any one of (2) to (4), in which the non-display portion is provided with a wiper (wiper 61, 62),

According to (5), even at the time of precipitation, it is easier for the occupant in the vehicle cabin to see the outside.

(6) The window according to any one of (2) to (5),

which is a rear window of the vehicle.

According to (6), it is possible to provide various kinds of information to the following vehicle and the like, and it is possible to prevent the information from being reflected by the water droplets even in rainy weather.

What is claimed is:

1. A window; which is provided with a vehicle display device for displaying information toward the outside of a vehicle, the window comprising:
a display portion on which the information is projected, wherein
at least a part of an outer surface of the display portion has hydrophilicity.

2. The window according to claim 1, further comprising:
a non-display portion on which the information is not projected, wherein
an outer surface of the non-display portion has hydrophobicity.

3. The window according to claim 2, wherein
the display portion is located below the window; and
a liquid guide portion for preventing liquid from entering the display portion is provided above the display portion so as to protrude from an outer surface of the window.

4. The window according to claim 3, wherein
the liquid guide portion includes:
an upper guide portion provided on an upper portion of the display portion, and
a left guide portion and a right guide portion provided on both sides in the vehicle width direction,
the left guide portion is configured to be inclined to a left side from the upper guide portion toward a lower side, and
the right guide portion is configured to be inclined to a right side from the upper guide portion toward the lower side.

5. The window according to claim 2, wherein
the non-display portion is provided with a wiper.

6. The window according to claim 2,
which is a rear window of the vehicle.
